(19) United States
(12) Patent Application Publication
(10) Pub. No.: US 2003/0053277 A1
(43) Pub. Date: Mar. 20, 2003

(54) Integrated circuit device with bump bridges and method for making the same

(76) Inventors: Joachim Christian Reiner, Thalwil (CH); Eckart Rzittka, Wildberg-Sulz (DE); Jose Solo De Zaldivar, Waedenswil (CH)

Correspondence Address: U.S. Philips Corporation, 580 White Plains Road, Tarrytown, NY, 10591, US

(21) Appl. No.: 10/228,441

(22) Filed: Aug. 27, 2002

(30) Foreign Application Priority Data
Aug. 29, 2001 (EP) 01120555.6

(51) Int. Cl. H02H 1/00

(52) U.S. Cl. 361/127

(57) ABSTRACT

Text Integrated circuit device (20) comprising a silicon substrate (21), integrated devices (22) with contacts (23.1, 23.2), an isolating layer (24) at least partially covering the integrated devices (22) and comprising conducting areas (24.1, 24.2) which establish a conductive path to the contacts (23.1, 23.2) of the integrated devices (22). A metallization level (25) with metal lines (26.1, 26.2, 26.3, 26.4) is provided which connect to one of the contacts (23.2). The metal lines (26.1, 26.2, 26.3, 26.4) are situated above the isolating layer (24). A passivation layer (27)—situated above the metallization level (25)—comprises at least two contact areas (28.1, 28.2) for partially exposing at least two of the metal lines (26.2, 26.4). A bump bridge (29) comprising a conductive, low-resistance material, is situated on the passivation layer (27). The bump bridge (29) has a high aspect ratio and provides for a conductive connection between at least two of the metal lines (26.2, 26.4). It crosses another metal line (26.3) that is situated within the metallization level (25), without making contact to this metal line (26.3), and a substantial part of the bump bridge (29) is supported by the passivation layer (27).

The present invention relates to integrated circuit devices with one metallization layer in general. In particular, the present invention relates to integrated circuit devices with ESD protection.

There are many integrated circuit devices that comprise just one metallization layer being patterned to provide for connections between the integrated circuits and to provide for connections to the outside.

The higher the integration density of these integrated circuit devices gets, the more difficult it is to realize the routing of all the necessary interconnections inside a single metallization layer. One of the problems is that one has to avoid crossings where a first metal line crosses a second metal line.

In situations where the routing cannot be realized with a single metallization layer, one currently has two options. Either, a few polysilicon interconnections are provided where necessary, or another metallization layer is added.

It is a disadvantage of the polysilicon interconnections, that due to the fact that the polysilicon has a low conductivity, the dimension of the polysilicon interconnections has to be chosen such that a sufficiently low resistance is obtained. This means that polysilicon interconnections usually are relatively big thus occupying part of the device's surface area that otherwise would be available for integrated devices.

A second metallization layer has the disadvantage that the costs for making such a device are impacted, since a second metallization layer requires additional processing and testing steps. In many cases this would render the integrated circuit device too expensive.

In a co-pending patent application Bumps on active (BOA), application number 00204814.8 and filing date Dec. 22, 2000, a novel concept is proposed which allows for the first time to realize metal bumps above an active circuit area. The invention presented herein builds on this co-pending patent application.

Quite often integrated circuit devices, such as CMOS devices for example, comprise an electrostatic discharge device (ESD) protection in order to prevent,the very sensitive circuits on the chip from being destroyed when it is subjected to a discharge event. This might happen for example when somebody induces a voltage peak into the circuitry by touching the pins of the chip.

The ESD protection of integrated circuit devices relies on low-ohmic interconnections within an ESD protection network. Such an ESD protection network comprises protection diodes and/or transistors and metal interconnection lines for connecting these diodes and/or transistors with inputs and/or outputs of the integrated circuit device to be protected. Often, the respective metal lines have to cross. In order to achieve such a crossing, two metallization layers have to be used. In the case of a single metal single polysilicon CMOS process for example, such a crossing will use metal for one track and a polysilicon interconnection or diffusion for the other one. Due to the high sheet resistance of the polysilicon or the diffusion, this has the drawback that either the resistance of the crossing is quite high or the crossing will use a lot of space, as mentioned above.

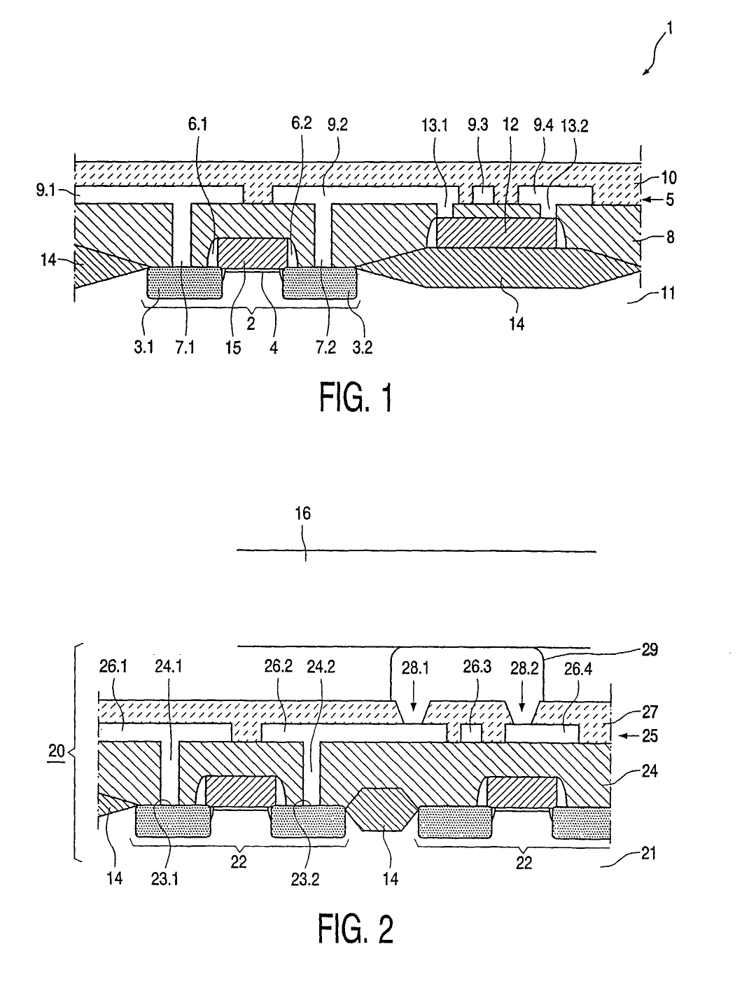

A schematic cross-section of a conventional integrated circuit device 1 with a polysilicon interconnection is illustrated in FIG. 1. The device 1 comprises a device 2 being integrated in a substrate 11. The device 2 is a transistor with drain and source diffusion regions 3.1 and 3.2 (e.g., n+diffusion regions), a channel 4, a polysilicon gate 15 and two spacers 6.1 and 6.2. The device 2 has two contacts 7.1, 7.2, and an isolating layer 8, e.g. a layer comprising PSG, covering the integrated device 2. There are conducting areas 9.1 and 9.2 which establish a conductive path to the contacts 7.1 and 7.2 of the integrated device 2. A metallization level 5 with metal lines 9.1, 9.2, 9.3, 9.4 provides electrical connections to the various devices of the integrated circuit device 1. A passivation layer 10 is formed on top of the metallization level 5. In order to provide for a low-ohmic connection between the metal lines 9.2 and 9.4, a thick polysilicon interconnection 12 is provided. The polysilicon interconnection 12 connects two metal vias 13.1, 13.2. The two vias 13.1, 13.2 are connected to the metal lines 9.2 and 9.4, respectively. There are field oxides 14 next to the device 2.

The size of the polysilicon interconnection 12 is mainly determined by the required conductivity. Polysilicon has a relatively high sheet resistance (R_{sq}) of about 40Ω. In order to provide a low-ohmic resistance, one needs to employ a bulky polysilicon interconnection. If the resistance of the interconnection is too high, thermal damage might occur in case of an ESD event.

The width of a polysilicon interconnection typically is in the order of 50 μm and the thickness in the order of 0.8 μm. When the polysilicon interconnection is designed to cross a 30 μm wide metal line (e.g., the metal line 9.3), the minimum area consumption would be about 50×36 μm². The resistance of such an interconnection would be about 20Ω. In order to realize a crossing with a resistance of less than 2Ω using a conventional polysilicon interconnection, one would need 10 times the area. Such a polysilicon interconnection would occupy about 18000 μm².

Adding a second metallization layer would render a chip too expensive and relying on the conventional polysilicon interconnections or diffusions has the drawbacks outlined above.

It is an object of the present invention to provide a scheme that overcomes the disadvantages of known approaches that are either too expensive or too bulky.

It is an object of the present invention to provide a scheme that allows for an improved interconnection of metal lines in integrated circuit chips having just one metallization layer.

It is an object of the present invention to provide a scheme that allows to add an ESD protection network to densely packed integrated circuit devices.

It is another object of the present invention to provide a method for making low-ohmic interconnections on an integrated circuit device having just one metallization layer.

This invention concerns a scheme that allows to provide low-ohmic interconnections on an integrated circuit device.

These and other objects are accomplished by an integrated circuit device, according to claim 1, that comprises a silicon substrate, integrated devices with contacts, an isolating layer (PSG) at least partially covering the integrated devices and comprising conducting areas which establish a conductive path to the contacts of the integrated devices, a metallization level with conducting metal lines providing electrical connections to at least one of the contacts, whereby the conducting metal lines are situated above the isolating layer, and a passivation layer above the metallization level, which comprises at least two contact areas for exposing at least two of the metal lines. The integrated circuit device further comprises a bump bridge comprising a conductive, low-resistance material, which is situated on the passivation layer, the bump bridge providing for a conductive connection between at least two of the metal lines. The bump bridge crosses another metal line that is situated within the metallization level, without making contact to this metal line, and a substantial part of the bump bridge is supported by the passivation layer. The bump bridge has a high aspect ratio allowing the bump bridge to establish a conductive connection to an interconnection on a substrate.

Further advantageous implementations are claimed in claims 2-11.

Advantageous driver circuits, according to the present invention, are claimed in claims 12-14. A driver device is disclosed and claimed for use in a display system that comprises at least one bump bridge in accordance with the present invention.

The method, according to the present invention, allows make integrated circuit devices with bump bridges. The method comprises the steps:

providing a semiconductor substrate with circuit devices,

providing an isolating layer at least partially covering the circuit devices,

providing contact areas in the isolating layer,

depositing a metal layer,

patterning the metal layer in order to define metal lines,

providing a passivation layer having at least two contact areas for partially exposing at least two of the metal lines,

providing a bump bridge. Said bump bridge comprises a conductive, low-resistance material, is situated on the passivation layer, and provides for a conductive connection between at least two of the metal lines. It crosses another metal line that is situated within the metallization level, without making contact to this metal line, and the bump bridge is supported by the passivation layer.

Various advantageous implementations and variations of the method are claimed in claims 16-19.

So far nobody has come up with the idea of using bump bridges in the manner described an claimed herein, since bumps are generally believed to cause short circuits if placed on top of existing integrated devices. When placing the bump bridges on a passivation layer that has well defined contact areas, the risks associated with the conventional bumps can be avoided. Other advantages are addressed in the detailed description or are apparent from the description and figures.

For a more complete description of the present invention and for further objects and advantages thereof, reference is made to the following description, taken in conjunction with the accompanying drawings, in which:

FIG. 1 is a conventional integrated circuit device with a bulky polysilicon interconnection;

FIG. 2 is an integrated circuit device, according to a first embodiment of the present invention, and a substrate;

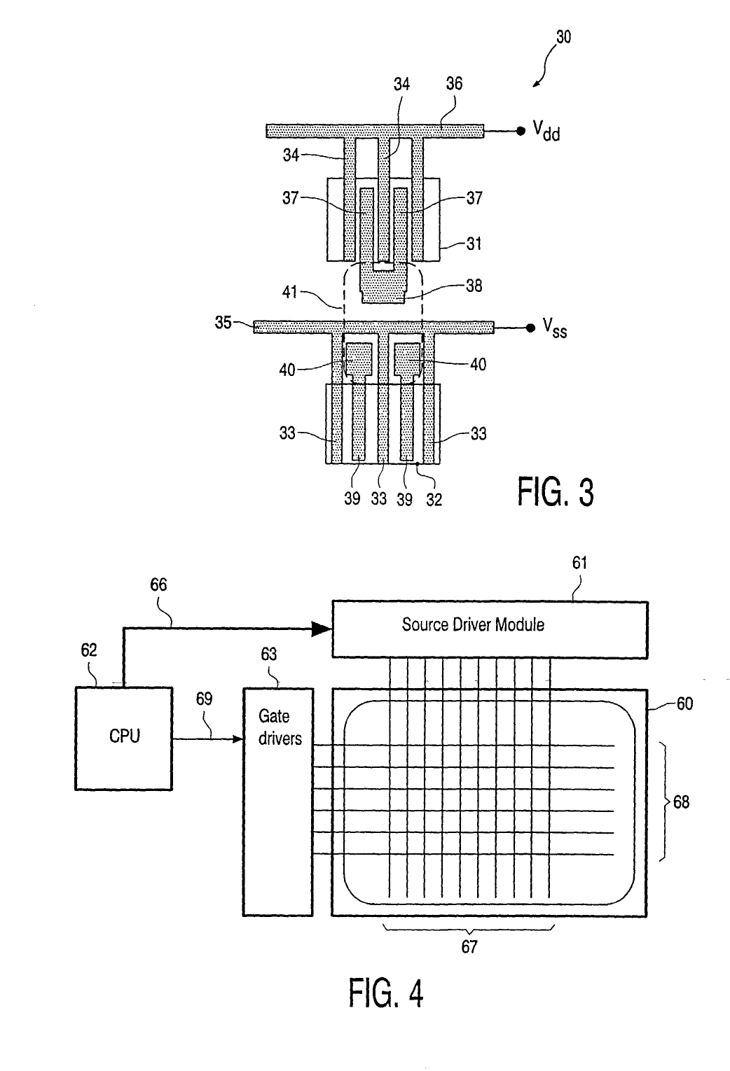

FIG. 3 shows part of an integrated circuit device according to another embodiment of the present invention;

FIG. 4 is a block diagram of a display with display drivers;

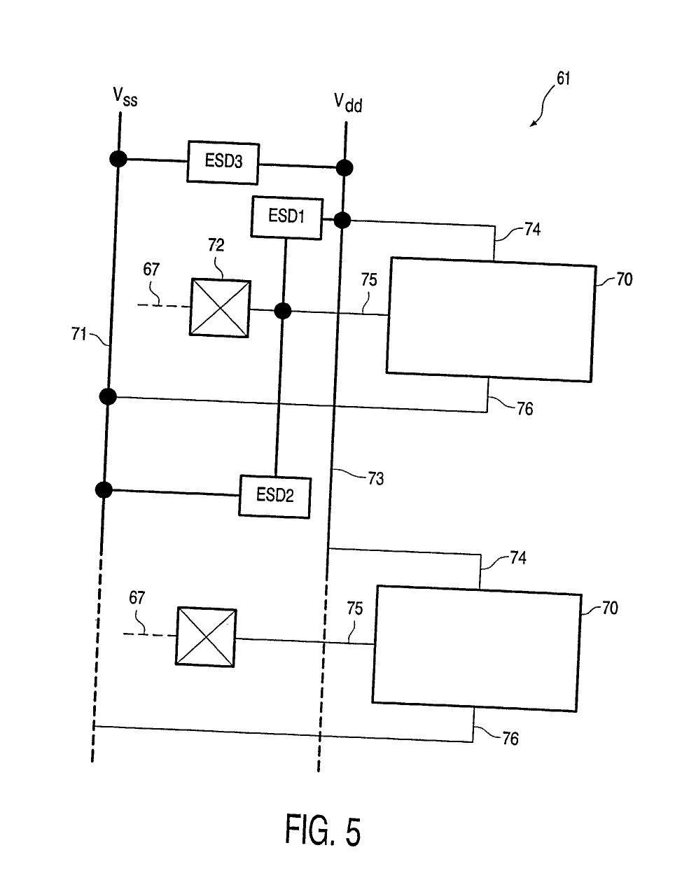

FIG. 5 shows part of driver circuit according to yet another embodiment of the present invention.

For reasons of clarity, the invention is illustrated hereafter on the basis of an integrated circuit device comprising a MOS transistor. It will be evident, however, to those skilled in the art that the integrated circuit device may contain a plurality of integrated devices, which need not to be restricted to MOS transistors, resistors, and capacitors, but can include bipolar transistors or DMOS/VDMOS transistors as well. Accordingly, the invention is applicable to CMOS and BICMOS integrated circuit devices in general.

A first embodiment of the present invention is depicted in FIG. 2. The schematic cross-section of an integrated circuit device 20 (in the present example a CMOS device) is shown that comprises a silicon substrate 21, at least one integrated device 22 (e.g., a transistor) with two contacts 23.1 and 23.2. An isolating layer 24 (e.g. comprising PSG) at least partially covers the integrated device 22. The layer 24 is patterned or formed so that conducting areas 24.1, 24.2 are provided which establish a conductive path to the contacts 23.1 and 23.2 of the integrated device 22.

The integrated circuit device 20 has a single metallization level 25 that is made by a formation of a metal layer and a subsequent patterning process. It is the purpose of this patterning process to provide metal lines 26.1, 26.2, 26.3, 26.4 that lay in the metallization level 25. These metal lines 26.1, 26.2, 26.3, 26.4 are providing electrical connections between the devices 22 that are integrated in the integrated circuit device 20. As illustrated, the metal lines 26.1, 26.2, 26.3, 26.4 are situated above the isolating layer 24. On top of the metal lines 26.1, 26.2, 26.3, 26.4, a passivation layer 27 is formed. The passivation layer 27 may comprise PSG, Si₃N₄ or SiO₂, for example. It comprises at least two contact areas 28.1 and 28.2 for partially exposing at least two of the metal lines 26.2 and 26.4. In the present example, the two contact areas 28.1 and 28.2 are extending through the passivation layer 27 down to the upper surface of the two metal lines 26.2 and 26.4. The two contact areas 28.1 and 28.2 can be viewed as windows that give access to the metal lines underneath.

It is now assumed that a low-ohmic interconnection between the two metal lines 26.2 and 26.4 is required, e.g. in order to be able to provide for a connection to an ESD device (not shown in FIG. 2). The problem is that there is another metal line 26.3 crossing and that there is an active device 22 located underneath. Assuming that this metal line 26.3 cannot be rerouted by changing the layout of the metallization level 25, one would have to employ a bulky polysilicon interconnection, in order to provide for a low-ohmic connection between the metal lines 26.2 and 26.4. Such a bulky polysilicon interconnection, however, would not leave sufficient space for active devices. According to the present invention, however, a bump bridge 29 is employed.

The bump bridge 29 comprises a conductive, low-resistance material. Preferably, the bump bridge 29 comprises gold (Au), titanium (Ti), titanium-tungsten (TiW), titanium nitride (TiN), Aluminum (Al), copper (Cu), or an alloy. It is also conceivable to use Pb/Sn bumps. As illustrated, the bump bridge 29 is situated on the passivation layer 27 such that it provides for a conductive connection between the metal lines 26.2 and 26.4. The bump bridge 29 crosses another metal line 26.3 without making contact, since part of the passivation layer 27 is located between the bump bridge 29 and this metal line 26.3. A substantial part of the bump bridge 29 is supported by the passivation layer 27. In other words, the bump bridge rests on the passivation layer 27. The bump bridge is a pedestal. It has an aspect ratio of 1:1 (vertical height versus lateral width) and preferably of 1:5 or less. The bump bridge not only bridges two metal lines. It also allows to provide for a connection to an interconnection on a substrate 16 (no such interconnections are shown in FIG. 2). When packaging the integrated circuit device 20, it is flipped onto the substrate 16, according to the well-known flip-chip technology. The substrate 16 with its interconnections may rest on several bump bridges.

In the following, the dimensions of one particular embodiment are given. The diffusion regions typically have a thickness of about 0.5 lm and the gate has a thickness of about 0.3 lm. The isolating layer 24 and the metallization layer may have a thickness of about 1 lm each. The passivation layer is between 0.5 and 2 lm thick. Bump bridges in accordance with the present invention have a thickness between 1.0 and 1000 μm. Typical examples are Al-bumps having a thickness of about 2-3 μm, Au-bumps having a thickness between 10 and 20 μm, and solder-bumps having a thickness of about 300 μm.

The bump bridge 29 can be much smaller than a polysilicon interconnection, since metals or alloys have a relatively low sheet resistance (R_{sq}). The sheet resistance of metal is typically in the range of about 0.1Ω to 0.001 . A small bump bridge 29 is sufficient in order to provide a low-ohmic resistance. The size of a bump bridge according to the present invention at least 10 times smaller than the size of a comparable polysilicon interconnection. A bump bridge in accordance with the present invention is capable of conducting currents of more than 1A.

The present invention is well suited for use in integrated circuit devices, such as CMOS devices for example, that comprise an electrostatic discharge device (ESD) protection. Part of an integrated circuit device 30 with a ESD output protection means is depicted in the schematic FIG. 3. The ESD protection of integrated circuit devices relies on low-ohmic interconnections within the ESD protection network. Such an ESD protection network comprises protection diodes and/or transistors and metal interconnection lines for connecting these diodes and/or transistors with inputs and/or outputs of the integrated circuit device to be protected. Where the respective metal lines have to cross since the routing in the metallization level does not allow a convenient interconnection, according to the present invention a bump bridge is employed.

The integrated circuit device 30, according to the second embodiment, comprises a plurality of integrated devices. Each of these devices has metal lines that are connected to the device's contacts. Note that these contacts are not visible in FIG. 3, since they are underneath the metal lines. Two integrated devices 31 and 32 are shown in FIG. 3. In this schematic top view the integrated devices 31 and 32 are depicted as rectangles. Both devices 31 and 32 are CMOS transistors. The metal lines 33 make contact to the diffusion regions of the transistor 32 and the metal lines 34 make contact to the diffusion regions of the transistor 31. The three metal lines 33 are connected through a metal line 35 to the supply voltage Vss and the three metal lines 34 are connected through the metal line 36 to the supply voltage Vdd. The transistor 31 has two metal lines 37 that are connected to the transistor's drain electrodes (the gate is not shown). The two metal lines 37 lead to a contact pad 38. The drain of the transistor 32 is connected to two metal lines 39. Due to layout constraints, each metal line 39 has its own contact pad 40. The transistor 31 is in the present embodiment part of an outputs stage of the integrated circuit device 30. In order to protect this output stage against voltage peaks, ESD protection means are provided. The transistor 32 is part of these ESD protection means. In order to be able to cope with the voltage peaks, the transistor 32 is a power transistor. It is a must to provide a low-ohmic connection between the drain of the transistor 31 and the drain of the transistor 32. In the present embodiment, a bump bridge 41 is situated above the metallization level in which the metal lines 33, 34, 35, 36, 37, and 39 are routed. For sake of clarity of the FIG. 3, the bump bridge 41 is shown as a transparent box. There is a passivation layer on top of the metal lines. This passivation layer is not illustrated in the FIG. 3. The bump bridge 41 is arranged such that it connects the contact pads 40 with the contact pad 38 without making any connection to the metal line 35 (Vss). The passivation layer mechanically supports the bridge 41 and provides for a separation between the bump bridge 41 and the metal line 35. In the present embodiment the bump bridge 41 serves two purposes since it provides for a crossing of a metal line and for a connection to ESD protection means.

Integrated circuit devices quite often have areas where the output or input metal lines have to cross power supply lines. A typical example is an integrated circuit display driver 61 or 63 that is designed to drive many lines of an LCD display 60, as illustrated in FIG. 4. Such a display driver 61, 63 typically has a large number of parallel outputs. In order to keep the cost for making such display drivers in an affordable range, one currently prefers to rely on a single metal CMOS process. Adding a second metallization layer would render the whole device too expensive. The bump-bridge technology presented herein is in particular suited for such integrated circuit devices. The bump bridges allow many output devices of the integrated circuit device 61 or 62 to cross the power supply lines which provide supply voltage (e.g., Vdd) to the output devices. A schematic block diagram of a display driver 61 in accordance with the present invention is given in FIG. 5. ESD protection means can easily be integrated into such a display driver 61.

Before addressing details of a display driver 61 in accordance with the present invention, a brief description of FIG. 4 is given. This Figure shows a schematic block diagram of an LCD display with control circuitry. The LCD display comprises an LCD screen 60 with a plurality of source lines 67 and a plurality of gate lines 68. A source driver module 61 is employed to drive the individual source lines 67. A gate driver 63 is employed that usually drives one whole gate line 68. The CPU 62 controls the scanning of all the gate lines 68 and source lines 67. For this purpose, the CPU 62 provides video signals (data signals and control signals), e.g., RGB-signals, via a bus 66 to the source driver module 61 and row timing signals (control signals) via a bus 69 to the gate driver 63. The source driver module 61 may comprise several source drivers. Usually, there is one source driver per source line. It is also possible, however, to use a source driver in a multiplexed fashion such that one and the same source driver can be used to drive several source lines 67.

Each output device 70 of a source driver module 61, for example, may comprise a digital-to-analog (D/A) converter, a buffer as well as other devices. The buffers drive the source lines 67 with the voltages needed by each pixel of the LCD screen 60. The source lines 67 are connected (e.g. by means of bonding) to contact pads 72, as illustrated in FIG. 5. There is an array of several parallel output devices 70 (two such output devices are shown in FIG. 5). The output 75 of each output device 70 is connected to a contact pad 72. There is a power supply line 73 which provides the supply voltage Vdd through connection 74 to the output devices 70. There is at least a second power supply line 71 which provides the supply voltage Vss through connection 76 to the output devices 70. These power supply lines 71 and 73 run perpendicular to the output lines 75 of the output devices 70. In the present embodiment, three ESD devices ESD1, ESD2, and ESD3 are provided for each output device 70, in order to protect the circuitry inside the devices 70. A first ESD device ESD1 is connected between the output line 75 and the power supply line 73. The second ESD device ESD2 is connected between the output line 75 and the power supply line 71. A third ESD device ESD3 is situated between the two power supply lines 71 and 73. The ESD devices may comprise diodes, transistors and other circuits that are suited to provide for a low-ohmic path to a terminal (e.g., a ground terminal) in case of a voltage peak. It is important that certain of the lines of the device 61 provide for a low-ohmic connection to the desired terminal. These lines are shown as bold lines. All other lines do not need to be low-ohmic. In order to be able to cross some of the lines, bump bridges can be employed. Preferably, the bump bridges form part of a low-ohmic connection. For all the other connections, polysilicon can be used. It is important for the protection mechanism to function properly, that there are low-ohmic connections.

It is to be noted that there may be a thin layer or a combination of several such layers between the passivation layer 27 and the bump bridge 29. This/these layer(s) may be employed to improve the adhesion between the bump bridge as such and the passivation layer on which it rests. In addition or likewise, this/these layer(s) may be designed in order to provide for an improved thermal coupling between the passivation layer and the bump bridge. This helps to spread temperature differences more evenly or to reduce the device temperatures in certain critical areas. The thin layer or the combination of several such layers may comprise titanium-tungsten (TiW), for example.

The bump bridge 29 can either be formed right on the upper surface of the metal lines 26.2 and 26.4 that are exposed, or the bump bridge 29 can be formed on top of an intermediate layer (e.g., a layer serving as plating base for an electro-plated bump bridge). The bump bridge 29 can also be formed on top of a barrier layer. Such a barrier layer may comprise TiW or Ti/Pt, for instance, and may have a thickness between 10 nm and 400 nm.

The bump bridges can be made using a sputter deposition or an electroplating process. The thickness is typically between 1.0 and 1000 μm. Preferably, the thickness of the bump bridges is between 3 and 30 μm.

In another embodiment of the present invention, the bump bridges are not only employed as bridges crossing one or more metal lines within the metallization level, but also to serve as output contact. Due to the size of the bump bridge, it can easily be contacted with wires or other means. The present invention may thus be used to simplify the packaging of integrated circuit devices.

In yet another embodiment, there are devices, such as coils, capacitors, resistors or the like combined with or integrated into the bump bridge. The bump bridges can also be designed in order to provide for a shield against radiation. This approach allows light sensitive integrated devices to be protected against external light, for instance. Certain types of transistors, for example, need to be protected against photons. A bump bridge can be arranged on top of the transistor so that is covers at least the sensitive areas. If the bump bridge is made of a metal, it will block photons.

The invention further relates to a method of manufacturing an integrated circuit device with bump bridges. The method at least comprises the following steps:

providing a semiconductor substrate 21 with circuit devices 22,

providing an isolating layer 24 at least partially covering the circuit devices 22,

providing contact areas 24.1, 24.2 in the isolating layer 24, e.g. by patterning the isolating layer after deposition,

depositing a metal layer 25,

patterning the metal layer 25 in order to define metal lines 26.1-26.4,

providing a passivation layer 27 having at least two contact areas 28.1, 28.2 for partially exposing at least two of the metal lines 26.2, 26.4,

providing a bump bridge by means of electroplating or (sputter) deposition, said bump bridge

comprising a conductive, low-resistance material, is situated on the passivation layer 27,

providing for a conductive connection between at least two of the metal lines 26.2, 26.4,

crossing another metal line 26.3 that is situated within the metallization level 25, without making contact to this metal line 26.3, and

being supported by the passivation layer 27.

The present invention is well suited for integrated circuit devices operating with two or more supply voltages (e.g., Vdd, Vee and Vss). In these kind of devices there is a need for many crossings which can be easily realized by means of the bump bridges in accordance with the present invention.

It is an advantage of the present invention that the integrated circuit devices can be made using a single metal single polysilicon CMOS process for example.

Many of today's integrated circuit device use solder bumps, gold bumps or the like, in order to provide for the connections of the device to the outside. This means that there are quite often processes already in place for making such solder bumps. Adding the inventive bump bridges to such devices thus does not require having to add completely new processing steps.

The present invention avoids having to employ bulky polysilicon interconnections or having to add another metallization level. Compared to integrated circuit devices having polysilicon interconnections, the solution presented herein allows to save chip area. This allows to realize more densely packed integrated circuit devices.

It is an advantage of the present invention not only that the bump bridges are smaller than any polysilicon interconnection of comparable resistance would be, but also that active devices can be situated in the substrate right underneath the bump bridge.

It is another advantage of the present invention, that the bump bridges are well suited for conducting the currents occurring during ESD events.

Devices in accordance with the present invention allow to avoid thermal damage caused by high current during an ESD event.

In the drawings and specification there has been set forth preferred embodiments of the invention and, although specific terms are used, the description thus given uses terminology in a generic and descriptive sense only and not for purposes of limitation.

1. Integrated circuit device (20) comprising:
a silicon substrate (21),
integrated devices (22) with contacts (23.1, 23.2),
an isolating layer (24) at least partially covering the integrated devices (22) and comprising conducting areas (24.1, 24.2) which establish a conductive path to the contacts (23.1, 23.2) of the integrated devices (22),
a metallization level (25) with metal lines (26.1, 26.2, 26.3, 26.4) providing electrical connections to at least one of the contacts (23.2), the metal lines (26.1, 26.2, 26.3, 26.4) being situated above the isolating layer (24),
a passivation layer (27) above the metallization level (25), which comprises at least two contact areas (28.1, 28.2) for partially exposing at least two of the metal lines (26.2, 26.4),
wherein
a bump bridge (29) comprising a conductive, low-resistance material, is situated on the passivation layer (27),
the bump bridge (29) provides for a conductive connection between at least two of the metal lines (26.2, 26.4),
the bump bridge (29) crosses another metal line (26.3) that is situated within the metallization level (25), without making contact to this metal line (26.3),
the bump bridge (29) having a high aspect ratio allowing the bump bridge (29) to be connected to a substrate (1 6) after packaging, and
that a substantial part of the bump bridge (29) is supported by the passivation layer (27).

2. The integrated circuit device (20) of claim 1, wherein the low-resistance material comprises gold (Au), or titanium (Ti), or titanium-tungsten (TiW), or titanium nitride (TiN), or aluminum (Al), or copper (Cu), or Pb/Sn, or an alloy.

3. The integrated circuit device (20) of claim 1 or 2, wherein the integrated devices (22) are transistors, preferably NMOS or PMOS transistors.

4. The integrated circuit device (20) of claim 1, 2 or 3, wherein the isolating layer (24) comprises Si3N4 or SiO2.

5. The integrated circuit device (20) of claim 1, 2, 3 or 4, wherein the passivation layer (27) comprises glass, preferably PSG, or Si₃N₄, or SiO₂.

6. The integrated circuit device (20) of one of the claims 1 through 5, comprising a thin layer or a sequence of thin layers being located between an upper surface of the passivation layer (27) and the bump bridge (29).

7. The integrated circuit device (20) of one of the claims 1 through 6, comprising a thin layer, preferably a barrier layer, being located on top of the metal lines (26.2, 26.4) being exposed in the two contact areas (28.1, 28.2) and underneath the bump bridge (29).

8. The integrated circuit device (20) of one of the preceding claims, wherein the bump bridge has a thickness between 1.0 and 1000 μm, and preferably between 3 and 30 μm.

9. The integrated circuit device (20) of one of the preceding claims, wherein the bump bridge has a sheet resistance in the range of about 0.1Ω to 0.001Ω.

10. The integrated circuit device (20) of one of the preceding claims, wherein the bump bridge (29) interconnects two or more metal lines.

11. The integrated circuit device (20) of one of the preceding claims, comprising ESD protection means (74), wherein the bump bridge (29) provides for a low-ohmic connection between a terminal of at least one of the integrated devices (22) to the ESD protection means (74), and/or wherein the bump bridge (29) provides for a low-ohmic connection between a power supply line of the integrated circuit device (20) and the ESD protection means (74).

12. Driver circuit (61) comprising:
a plurality of integrated devices (70) each having an output contact (72) and a supply voltage contact,
a metallization level with metal lines (74, 75, 76) providing for electrical connections to the output contacts (72) and the supply voltage contacts of the integrated devices (70),
a passivation layer above the metallization level, which comprises at contact areas for partially exposing several of the metal lines,
a plurality of bump bridges comprising a conductive, low-resistance material, being situated on the passivation layer,
each of the bump bridges providing for a conductive connection between at least two of the several metal lines,
the bump bridges crossing a metal line that is situated within the metallization level, without making contact to this metal line,
the bump bridge having a high aspect ratio allowing the bump bridge to be connected to a substrate after packaging, and
that a substantial part of the bump bridge being supported by the passivation layer.

13. The driver circuit (61) of claim 12, further comprising ESD protection means (74), whereby at least some of the bump bridges (71) provide for a low-ohmic connection to or from the ESD protection means (74).

14. Display driver circuit comprising a driver circuit according to claim 12 or 13.

15. Method for making an integrated circuit device with bump bridges, comprising the steps:
providing a semiconductor substrate (21) with circuit devices (22),
providing an isolating layer (24) at least partially covering the circuit devices (22),
providing contact areas (24.1, 24.2) in the isolating layer (24),
depositing a metal layer (25),
patterning the metal layer (25) in order to define metal lines (26.1-26.4),
providing a passivation layer (27) having at least two contact areas (28.1, 28.2) for partially exposing at least two of the metal lines (26.2, 26.4),
providing a bump bridge (29), said bump bridge (29)
comprising a conductive, low-resistance material, is situated on the passivation layer (27),
providing for a conductive connection between at least two of the metal lines (26.2, 26.4),
crossing another metal line (26.3) that is situated within the metallization level (25), without making contact to this metal line (26.3),
having a high aspect ratio, and
being supported by the passivation layer (27).

16. The method of claim 15, whereby the isolating layer (24) deposited and then patterned after deposition in order to form the contact areas (24.1, 24.2) in the isolating layer (24).

17. The method of claim 15 or 16, whereby the bump bridge (29) is formed by means of electroplating or deposition.

18. The method of claim 15, 16 or 17, wherein bump bridge (29) comprises gold (Au), or titanium (Ti), or titanium-tungsten (TiW), or titanium nitride (TiN), or aluminum (Al), or copper (Cu), or Pb/Sn, or an alloy.

19. The method of one of the claims 15-18, wherein the integrated circuit device is flip-chip mounted on a substrate, whereby the bump bridges provide for a conductive connection between elements on the integrated circuit device and interconnections being part of the substrate.
